(19) United States
(12) Patent Application Publication
(10) Pub. No.: US 2017/0246709 A1
(43) Pub. Date: Aug. 31, 2017

(54) CONTROL OF LASER ABLATION CONDENSATE PRODUCTS WITHIN ADDITIVE MANUFACTURING SYSTEMS

(71) Applicant: Moog Inc., East Aurora, NY (US)

(72) Inventors: Paul Guerrier, Tewkesbury (GB); Ian L. Brooks, Gloucester (GB)

(21) Appl. No.: 15/509,019

(22) PCT Filed: Sep. 17, 2015
(86) PCT No.: PCT/US15/50635

§ 371 Date: Mar. 6, 2017

Related U.S. Application Data
(60) Provisional application No. 62/052,521, filed on Sep. 19, 2014.

(51) Int. Cl. B23K 26/16; B23K 26/12; B33Y 10/00; B29C 67/00; B33Y 40/00; B23K 26/70; B22F 3/105; B23K 26/342; B33Y 30/00

(52) U.S. Cl. CPC B23K 26/16; B23K 26/342; B23K 26/127; B23K 26/123; B33Y 10/00; B33Y 30/00; B33Y 40/00; B23K 26/706; B22F 3/1055; B29C 67/0077; B29C 67/0085; B22F 2003/1059; B22F 2998/10

(57) ABSTRACT

Byproduct condensate generated during additive manufacturing is controlled by providing at least one electrode inside a chamber. The condensate may be electrically charged as it is generated or an electrical charge may be imparted to the condensate. The electrode may have either a positive or negative bias to either attract or repel the condensate. The electrode may be located on a wall of the chamber or associated with a transparent window through which a laser beam passes into the chamber.

### CROSS-REFERENCE TO RELATED APPLICATIONS

This application claims priority to the provisional patent application entitled “Control of Laser Ablation Condensate Products within Additive Manufacturing Systems,” filed Sep. 19, 2014 and assigned U.S. App. No. 62/052,521, the disclosure of which is hereby incorporated by reference.

### FIELD OF THE INVENTION

This invention relates to additive manufacturing and, more particularly, to an additive manufacturing system that controls condensate.

### BACKGROUND OF THE INVENTION

Additive manufacturing enables fabrication of three-dimensional objects from a model or another electronic data source through additive processes in which successive layers of material are laid down. A laser beam is used to fuse a previously-leveled powder surface into a thin sheet of solid material. A further layer of powder is applied on top of the previously-fused thin sheet and the process is repeated until a three-dimensional object is built layer-by-layer. This process is known as, for example, powder bed fusion (PBF), laser selective melting, or direct laser metal sintering. The process may be applied to metals, plastics, or other materials that can be fused together.

The additive manufacturing process may be contained in a chamber filled with an inert gas to prevent unwanted chemical reactions. This inert gas may be, for example, argon. During the layer fusion process, vaporized material condenses into nanometer-sized dust, referred to herein as “condensate.” This condensate is initially suspended in the inert gas within the chamber. While some condensate is directed toward a filter in the chamber, a significant portion of the condensate may accumulate in and around the chamber.

Settled condensate may build up on the chamber walls, the transparent window through which the laser beam is directed, and the object being manufactured. The laser beam may be obscured and the additive manufacturing process may be interrupted or degraded if condensate settles on the transparent window. For example, an object may take 10 to 200 hours to build in an additive manufacturing system. However, the transparent window may be obscured after only approximately five hours of use due to deposits that have formed. It may be necessary to pause and clean the system if the transparent window is obscured.

Condensate build-up on chamber walls or in other locations in the chamber can be a fire risk, which presents a safety issue for operators. Some materials in the condensate may be highly-reactive in air, which may lead to spontaneous ignition if enough condensate has accumulated and the chamber is opened for cleaning or maintenance. For example, titanium or aluminum condensate can be formed during laser processing. Titanium or aluminum dust is a fire hazard and, when exposed to air, may pose an explosion hazard.

Any condensate build-up on the object being manufactured can impact the quality or properties of this object. For example, condensate may reduce fidelity or impact the shape, dimensions, or physical properties of the object being manufactured. The condensate build-up may even ruin the object being manufactured. Thus, there may be a maximum build time that can be performed before the chamber and transparent window need to be cleaned due to the presence of the condensate. This may render additive manufacturing unsuitable for fabricating large or complex objects.

One known approach to this problem, alluded to above, is to direct a flow of the inert gas through a filter in the chamber to trap condensate. However, it is difficult to control the exact trajectory of the condensate with only the inert gas flow. Some condensate may be accidentally directed over and onto the object being formed.

The chamber walls and transparent window can be manually cleaned. However, this is time-consuming and labor-intensive. It results in lowered throughput of the additive manufacturing system due to the frequent cleanings or preventative maintenance. Depending on the material used in the system, manual cleaning can be dangerous due to the risk of fire or explosion.

Therefore, what is needed is an improved additive manufacturing system and an improved method of operating an additive manufacturing system that alleviates the problems posed by condensate.

### BRIEF SUMMARY OF THE INVENTION

An additive manufacturing system embodying the present invention generally comprises a transparent window, a powder bed, and multiple walls. The walls and transparent window form a chamber around the powder bed. The system further comprises a laser source arranged to direct a laser beam into the chamber through the transparent window toward the powder bed, thereby generating condensate in the chamber. The condensate may have and retain an electrical charge as the condensate is formed, or the condensate may be electrically charged by applying an electrostatic field to the chamber as the condensate is formed. In accordance with the present invention, an electrode is disposed in the chamber to control electrically charged condensate. The electrode may be biased to attract or repel the electrically charged condensate. In one embodiment, the electrode is a transparent electrode disposed on the transparent window and biased to repel the electrically charged condensate away from the transparent window.

The invention extends to a method of additive manufacturing comprising the steps of directing a laser beam through a transparent window into a chamber to fuse powder in a powder bed, wherein electrically charged condensate is generated from the powder, and applying an electrical bias to an electrode disposed in the chamber to attract or repel the electrically charged condensate.

### DESCRIPTION OF THE DRAWINGS

For a fuller understanding of the nature and objects of the invention, reference should be made to the following detailed description taken in conjunction with the accompanying drawings, in which:

FIG. 1 is a schematic diagram of an additive manufacturing system formed in accordance with known prior art;

FIG. 2 is a schematic diagram of an additive manufacturing system formed in accordance with an embodiment of the present invention;

FIG. 3 is a schematic diagram of an additive manufacturing system formed in accordance with another embodiment of the present invention;

FIG. 4 is a schematic diagram of an additive manufacturing system formed in accordance with another embodiment of the present invention; and

FIG. 5 is a schematic diagram of an additive manufacturing system formed in accordance with a further embodiment of the present invention.

### DETAILED DESCRIPTION OF THE INVENTION

Although claimed subject matter will be described in terms of certain embodiments, other embodiments, including embodiments that do not provide all of the benefits and features set forth herein, are also within the scope of this invention. Various structural, logical, process step, and electronic changes may be made without departing from the scope of the invention. Accordingly, the scope of the invention is defined only by reference to the appended claims.

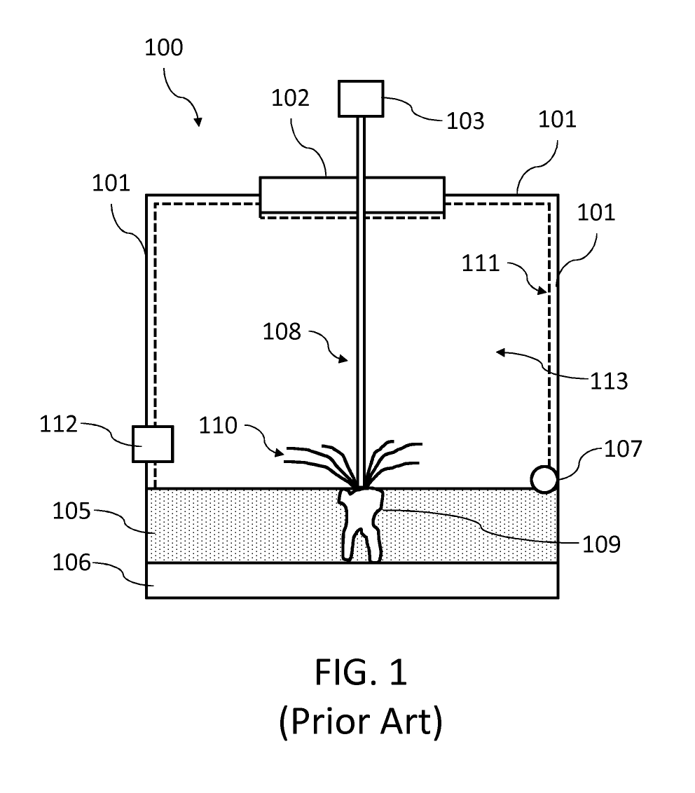

FIG. 1 is a schematic diagram of a known additive manufacturing system 100. Additive manufacturing system 100 has multiple walls 101 and a transparent window 102, which may be quartz glass or another transparent material suitable for transmitting a laser beam. The walls 101 and transparent window 102 cooperate to define a chamber 113. By way of non-limiting example, chamber 113 may measure approximately 5 feet×2 feet×2 feet. Chamber 113 may be brought to vacuum and filled with an inert gas, such as, for example, argon or another noble gas. A laser source 103 is arranged to generate and project a laser beam 108 through transparent window 102 toward a powder bed 106 located within chamber 113.

Powder bed 106 contains powder 105. Powder bed 106 may be fixed or may be part of an elevator system. An object 109 is formed by fusing thin layers of powder 105 using laser beam 108. Laser beam 108 may be scanned over a predetermined target area of powder bed 106 to fuse powder 105 into a layer having a desired shape. A wiper 107 is operable to apply additional layers or levels of powder 105 over the top fused layer of object 109 so that additional layers of the object 109 can be formed using laser beam 108.

As the powder 105 is fused to form the layers of object 109, condensate 110 is generated. The condensate 110 may be nanometer-sized particles, which are initially suspended in the chamber 113. Some of the condensate 110 forms deposits 111 (represented by dotted lines) on the walls 101 and transparent window 102. Some condensate 110 may be directed by a fan (not shown) toward filter 112 for capture or removal, but this filter 112 may not remove all the condensate 110 in the chamber 113.

The condensate 110 may carry an electric charge due to the process that forms the condensate 110. Without being limited to a particular mechanism, this electrical charge may be imparted from the photons of the laser beam 108 during boiling or sparking. Alternatively, a charge may be applied to the condensate 110. For example, a bias can be applied to the powder bed 106 or the powder 105.

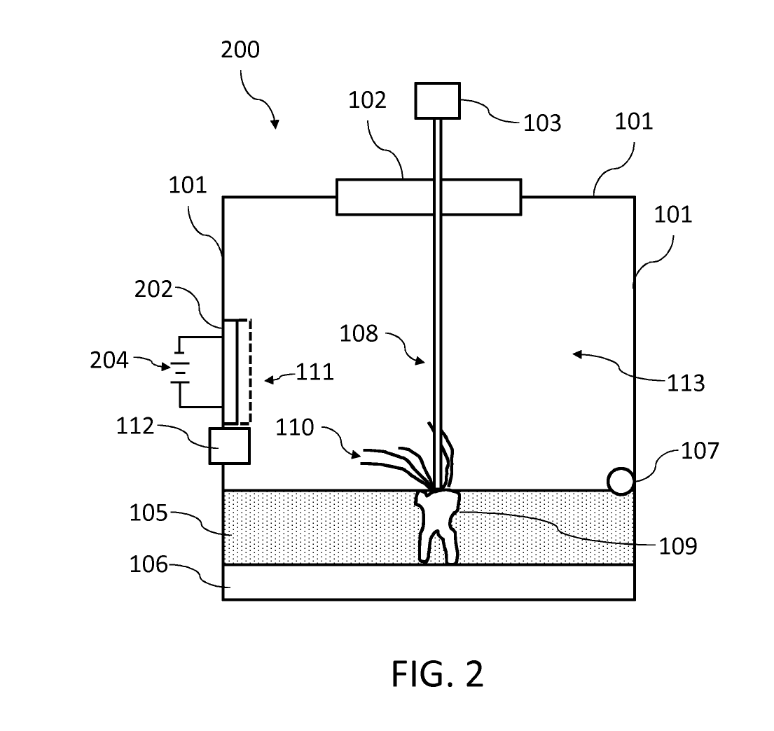

Reference is now made to FIG. 2, which depicts an additive manufacturing system 200 formed in accordance with an embodiment of the present invention. Additive manufacturing system 200 is generally similar to additive manufacturing system 100, however system 200 includes at least one electrode 202 disposed in chamber 113 and connectable to a voltage source 204. In FIG. 2, electrode 202 is illustrated as being biased to attract the electrically charged condensate 110. In particular, electrode 202 may be biased to have the opposite polarity as condensate 110, whereby the condensate 110 is attracted toward electrode 202. By way of example, condensate 110 may be negatively charged and voltage source 204 may provide a +100 V bias to the electrode 202, though other bias potentials are possible. Voltage source 204 may be connectable to electrode 202 by a switch (not shown) to allow the electrode bias to be shut off or applied as desired.

As shown in FIG. 2, electrode 202 may be positioned on or in one of the walls 101 of chamber 113. In FIG. 2, electrode 202 is positioned near filter 112 such that most of the condensate 110 either forms a deposit on electrode 202 or is directed into filter 112. Consequently, build-up of condensate 110 on the transparent window 102 is reduced. Other positions of electrode 202 are possible, and FIG. 2 merely illustrates an example.

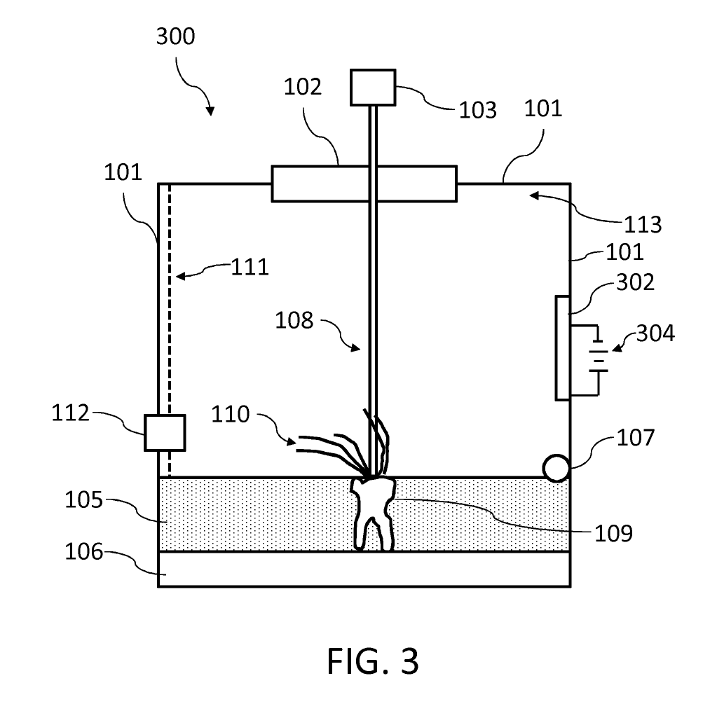

FIG. 3 depicts an additive manufacturing system 300 formed according to an alternative embodiment wherein an electrode 302 is biased to have the same polarity as condensate 110, such that the condensate 110 is repelled away from electrode 302 toward another region of chamber 113. Electrode 302 is connectable to a voltage source 304 through a switch (not shown). As an example, condensate 110 may be negatively charged and voltage source 304 may provide a −100 V bias to electrode 302, though other bias potentials are possible.

As shown in FIG. 3, electrode 302 may be positioned on or in one of the walls 101 of chamber 113. In FIG. 3, the condensate deflection electrode 302 is positioned opposite of the filter 112 to direct condensate 110 toward the filter and against the opposite wall 101. In this way, most of the condensate 110 may be prevented from forming a deposit on transparent window 102. Instead, most of the condensate 110 is either captured by filter 112 or forms a deposit 111 on an opposite wall 101 of chamber 113. Other positions of electrode 302 are possible, and this is merely an example.

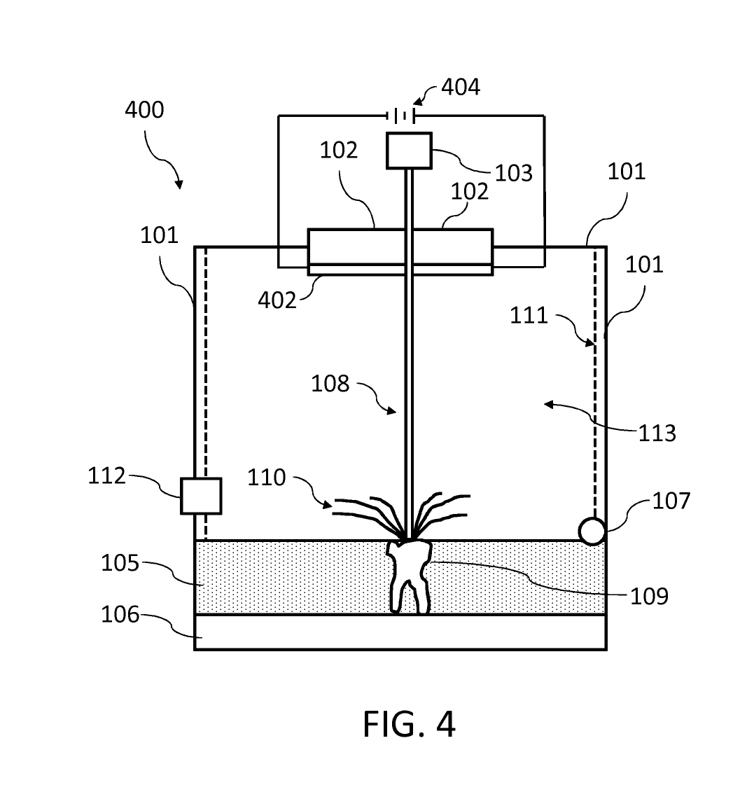

FIG. 4 is a schematic diagram of an additive manufacturing system 400 formed in accordance with another embodiment of the present invention. Additive manufacturing system includes a transparent electrode 402 disposed on transparent window 102. Electrode 402 is connectable to a voltage source 404 by way of a switch. Consequently, an electrical bias can be selectively applied to electrode 402, wherein the bias is of the same polarity as condensate 110. As will be understood, the biased electrode 402 repels condensate 110 away from transparent window 102 and electrode 402 so that deposits do not degrade the optical transmission path. The repelled condensate 110 may form deposits 111 on the walls 101 away from transparent window 102. In one example, voltage source 404 provides a −100 V bias to transparent electrode 402 to repel negatively charged condensate. Other biasing potentials are possible, and an opposite polarity bias is possible.

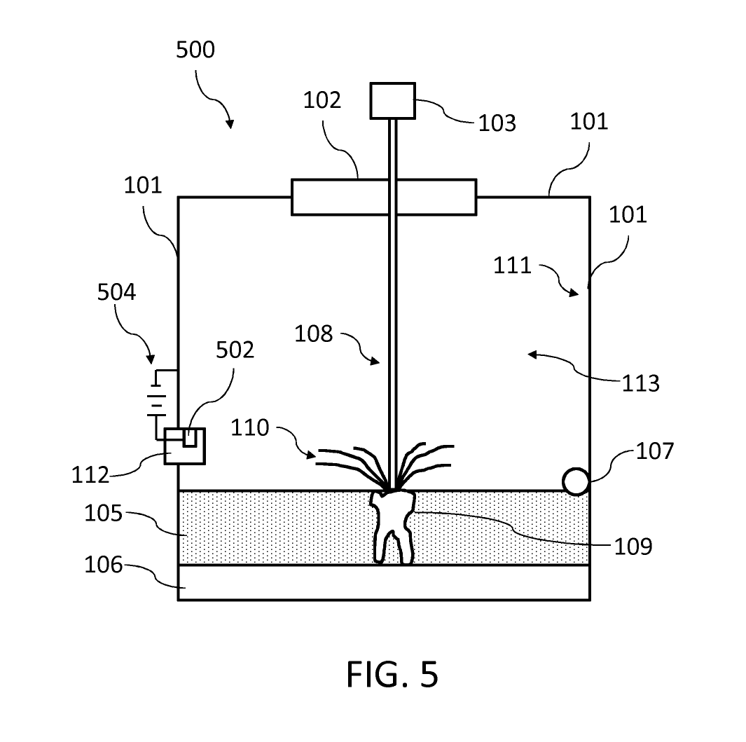

In a further aspect of the present invention, the filter 112 may be an electrostatic filter to further attract condensate 110. An electrode, such as one of the electrodes disclosed herein, can be arranged in the filter. FIG. 5 is a schematic diagram of an additive manufacturing system 500 formed in accordance with a further embodiment of the present invention. The electrode 502 is positioned on or in the filter 112. For example, the electrode 502 may be on or in an entrance to the filter 112 or may be inside the filter 112. The electrode 502 is connectable to a voltage source 504 by way of a switch. Consequently, an electrical bias can be selectively applied to electrode 502, wherein the bias is of the same or opposite of polarity of the condensate 110. The electrode 502 can be configured to attract condensate 110 to the filter 112 or retain condensate 110 in the filter 112.

As an alternative to using a transparent electrode positioned on widow 102, a wire or plate electrode (not shown) may be incorporated into window 102 in a region that does not block laser beam 108 and may be biased to repel condensate way from the window.

The electrodes 202, 302, 502 may be fabricated of any conducting material, such as a metal or graphene. The transparent electrode 402 may be fabricated of a transparent conductive material. For example, window 102 may be coated with thin film of indium tin oxide (ITO), iridium, or graphene as a transparent electrode material.

Electrodes 202, 302, 402, and 502 can be any suitable shape. While rectangular plates, sheets or films are illustrated, a rod or some other shape may be used. The size of the electrode can vary. For example, electrode 202 or 302 can encompass less than 50%, more than 50%, or an entirety of the area of a wall 101 of chamber 113. The shape and size of the various electrodes may be configured to minimize any effect on the vacuum formed in the chamber 113 and/or any effect on magnetics used in the system, such as if electron beam welding is performed.

While a single electrode is illustrated in each of FIGS. 2-5, multiple electrodes also may be used. The positioning or operation of the multiple electrodes may complement each other and/or direct a flow of condensate 110. For example, an electrode arranged in one region of chamber 113 may be biased to repel condensate toward another region of the chamber wherein an oppositely biased electrode is arrange to attract the condensate. The multiple electrodes may be used simultaneously, at overlapping times, or at different times. Thus, the multiple electrodes can be synchronized or coordinated to optimize collection of the condensate 110.

Furthermore, the various embodiments of FIGS. 2-5 may be combined. For example, a transparent condensate deflection electrode 402 may be used with one or more other electrodes 202, 302, or 502. In an instance, condensate 110 may be repelled from the transparent window 102 by transparent electrode 402 and attracted to another electrode 202. The bias applied to the various electrodes disclosed herein can vary. This bias can be, for example, pulsed or constant.

While the voltage sources in the embodiments disclosed herein are illustrated as having two connections to the electrode, other designs are possible. For example, only one end of the voltage source in FIGS. 2-5 may be connected to the electrode and the other end of the voltage source may be connected to a wall of the chamber or to the powder bed.

The various electrodes disclosed herein can be used in conjunction with the flow of the inert gas in the chamber 113. This gas flow may, for example, help move condensate 110 away from the transparent window 102, away from the object 109, or toward the filter 112.

In an example, the various electrodes, with or without the flow of the inert gas in the chamber 113, may be operated to direct condensate toward a collection device. This collection device may be, for example, a clam shell or trap door system. The collection device contains condensate 110 or deposits 111 and, prior to service or maintenance, can close so that the condensate 110 or any deposits 111 formed therein are kept in an inert atmosphere. The collection device may be connected to a water source to render the condensate or deposits safer while still in an inert atmosphere.

The various electrodes disclosed herein also can be operated in conjunction with one another (with or without the flow of the inert gas in the chamber 113) to coat the object 109 with condensate 110. In some instances, a deposit 111 may have a potential optical effect to improve formation of the object 109. This may be done on a timer or may be incorporated into the build instructions for particular layers of the object 109.

The voltage applied to the electrodes disclosed herein can vary. For example, the voltage may be greater than 0.1 kV or greater than 1 kV. The voltage may be, for example, between 0.1 kV to 1 MV. In an instance, the voltage may be between 1 to 3 kV or 1 to 5 kV.

It was found during testing that a 3 kV charge to an electrode attracted condensate particles toward the electrode. Some of the condensate particles were retained on the electrode using this 3 kV charge.

To improve safety, the condensate deposits may be directed so as to form a concentrated block instead of a thin film. Some powders, such as titanium, can be dangerous when in the form of a thin film because of the increased surface area. Heat or a binder chemical may be provided to help form the concentrated block. In one example, deposits 111 or condensate 110 are collected in one area of the chamber 113 and then agglomerated into a larger block through use of heat or a binder chemical.

Use of electrodes to attract or repel condensate can extend build times between cleanings, improve the quality of the object, reduce maintenance activity, and improve operator safety. Extended build times allow larger or more complex objects to be built. The quality of the object may be improved because spot control of the laser beam is improved. Maintenance activity is reduced because less time is needed to manually clean the chamber if deposits are reduced or preferentially formed in only particular regions of the chamber. Control of the condensate improves safety by reducing the risk of fire and the risk that harmful fumes will be released when the additive manufacturing system is cleaned or serviced.

Although the present invention has been described with respect to one or more particular embodiments, it will be understood that other embodiments of the present invention may be made without departing from the scope of the present invention. Hence, the present invention is deemed limited only by the appended claims and the reasonable interpretation thereof.

What is claimed is:

1. An additive manufacturing system comprising:
a transparent window;
a powder bed;
a plurality of walls, wherein the walls and the transparent window define a chamber around the powder bed;
a laser source that directs a laser beam into the chamber through the transparent window toward the powder bed; and
an electrode disposed in the chamber, wherein the electrode is biased to attract or repel the condensate due to an electrical charge of the condensate.

2. The system of claim 1, wherein the electrode is disposed on one of the walls.

3. The system of claim 1, wherein the electrode is disposed on or in the transparent window.

4. The system of claim 3, wherein the electrode is transparent.

5. The system of claim 4, wherein the electrode comprises at least one of indium tin oxide, graphene, or iridium.

6. The system of claim 1, further comprising a filter, and wherein the electrode is arranged and biased to deflect the electrically charged condensate toward the filter.

7. The system of claim 1, further comprising a filter, and wherein the electrode is arranged in the filter.

8. The system of claim 1, further comprising a second electrode disposed in the chamber, wherein the second electrode is biased to attract or repel the electrically charged condensate.

9. The system of claim 1, wherein the electrode is a sheet.

10. The system of claim 1, wherein the electrode is a plate

11. The system of claim 1, wherein the electrode is a rod.

12. The system of claim 1, wherein the electrode comprises a metal.

13. The system of claim 1, wherein the electrode comprises graphene.

14. A method of additive manufacturing comprising:
directing a laser beam through a transparent window into a chamber to fuse powder in a powder bed, wherein condensate is generated from the powder; and
applying an electrical bias to an electrode disposed in the chamber to attract or repel the condensate due to an electrical charge of the condensate.

15. The method of claim 14, further comprising the step of applying the electrical charge to the powder of the condensate.

16. The method of claim 14, wherein the electrode is arranged and biased to direct the electrically charged condensate toward a filter in the chamber.

17. The method of claim 14, wherein the electrode is arranged and biased to repel the electrically charged condensate away from the transparent window.

18. The method of claim 17, wherein the electrode is disposed on or in the transparent window.
